(19) United States
(12) Patent Application Publication
(10) Pub. No.: US 2023/0027923 A1
(43) Pub. Date: Jan. 26, 2023

(54) Worm Drive

(71) Applicant: Robert Bosch GmbH, Stuttgart (DE)

(72) Inventor: Joachim Rosenthal, Bartholomae (DE)

(21) Appl. No.: 17/791,797

(22) PCT Filed: Nov. 18, 2020
(86) PCT No.: PCT/EP2020/082462

§ 371 Date: Jul. 8, 2022

(30) Foreign Application Priority Data
Jan. 11, 2020 (DE) 10 2020 200 285.1

(51) Int. Cl. B62D 5/04

(52) U.S. Cl. CPC B62D 5/0454; B62D 5/0409

(57) ABSTRACT

A worm drive for a power steering system of a motor vehicle is disclosed. The worm drive includes a worm gear, a worm which meshes with the worm gear, and an electric motor which drives the worm. One side of the worm is connected by a coupling to the electric motor and the other side of the worm is mounted in a floating bearing. The coupling consists of a hub and an elastic spring bush. The floating bearing is oval-shaped in order to allow vertical movements of the worm, and the worm is spring-loaded on the worm gear by the coupling.

The present invention relates to a worm drive for a power-assisted steering system of a motor vehicle.

### PRIOR ART

The auxiliary torque made available by the electric motor is transmitted to the rack by means of the servo mechanism. For this purpose, the rotating movement of the electric motor is converted into a translational movement of the rack. In addition, the rotational speed and torque level supplied by the electric motor must be adapted to the requirements of the steering by means of a corresponding transmission ratio of the servo mechanism. Worm drives are often used for this purpose in electric power-assisted steering systems.

One problematic aspect of such worm drives is the drive backlash which develops as a result of component tolerances, different thermal expansion of the drive elements, and wear. In particular, in the case of what is referred to as alternate steering, that is to say in the case of directly successive steering with alternate steering angles, such a drive backlash produces unwanted noises resulting from the alternating abutment of opposite flanks of the teeth of the worm and the gear.

It is known that this drive backlash can be eliminated by spring-loading and pivotably mounting the worm. This is accomplished by means of special spring plates, which are connected to the fixed bearing of the worm via holders or sleeves and are fastened in the housing by means of an adjusting screw. However, this design is complex and expensive.

Proceeding from this prior art, it was the object of the invention to provide a worm drive having simplified spring loading. By means of a slimmer design and fewer components, the intention is to reduce the costs for the worm drive and, in addition, the weight. Furthermore, the intention is to improve noise damping in the case of dynamic influences on the worm drive.

This object is achieved by means of the subject matter of claim 1. Advantageous embodiments are the subject matter of the additional patent claims and will be found in the following description of the invention.

Since the worm executes slight oscillating movements during the rolling contact process, a coupling must be inserted between the drive shaft of the motor and the worm.

According to the invention, the coupling comprises a hub and an elastic spring bush. One concept of the present invention is that the coupling assumes several functions.

### Torque Transmission

First, the coupling transmits the torque. For this purpose, the worm is connected to the elastic spring bush by an interference fit. The other side of the hub is connected to the drive shaft of the motor by an interference fit. Moreover, the spring bush is connected to the hub by an interference fit. In addition, a slot can be provided on the elastic spring bush as a safeguard against spinning in the case of torque peaks and it engages in an integrated key on the hub.

### Fixed Support for the Worm

The elastic spring bush also provides the fixed support for the worm. This eliminates the need for an additional fixed bearing for the worm. The actual fixed bearing is on the drive shaft of the motor.

### Spring-Loading of the Worm

The elastic spring bush also provides the spring-loading of the worm in order to ensure meshing without backlash. As soon as the worm gear has been mounted, the worm is preloaded onto the worm gear. For this purpose, the center distance a between the worm and the worm gear is reduced by a preloading dimension x (e.g. 0.5 mm) in order to obtain the desired preloading force of the worm onto the worm gear. The concentricity tolerances of the worm and worm gear and the tooth profile wear of the worm gear are thereby compensated for without backlash over the service life of the drive, ensuring that the tooth flanks bear against one another in any load state of the steering assistance and at any time. This guarantees backlash-free steering assistance and prevents noises due to the worm which could arise on account of vehicle vibrations and changes in direction. The rubber-elastic spring mounting additionally ensures that torque peaks which arise as a result of the driving dynamics are damped or cushioned. This protects the components of the drive and prevents troublesome noises. The Shore hardness of the rubber-elastic spring mounting is selected in such a way that the idle starting torque of the worm drive is as low as possible and the spring-loading of the worm onto the worm gear is as taut as possible. The optimum is determined by tests. In this context, the elastic material can consist of elastomer or rubber.

### Floating Bearing Bush

The other side of the worm is connected to an oval floating bearing bush. The oval shape of the floating bearing bush allows the spring-loaded travel of the worm for backlash compensation but prevents lateral drifting of the worm during the rolling contact process. In the case of drives with higher torques, it is likewise possible to provide spring loading by means of rubber-elastic material between the inner and outer ring. In the case of drives with lower torques, such additional spring loading is not necessary.

An exemplary embodiment is described with reference to the figures. More specifically:

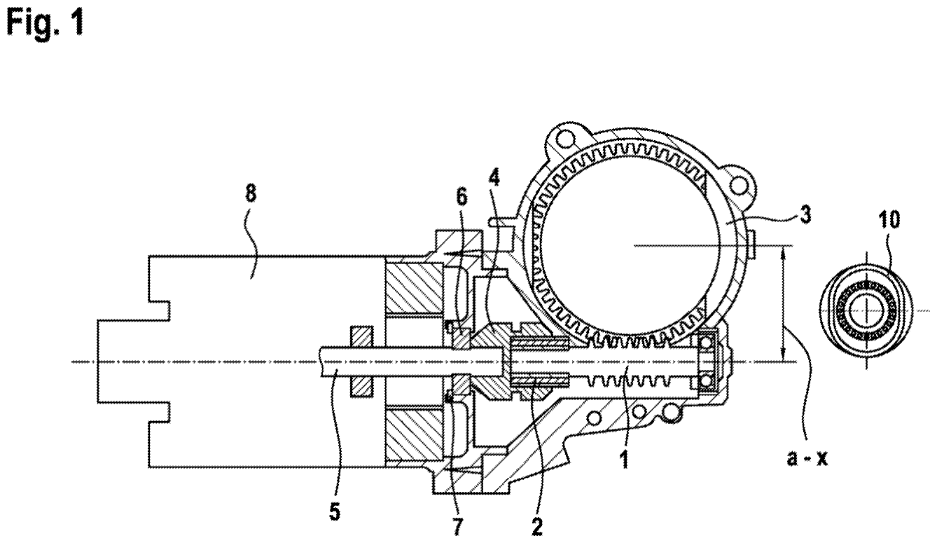

FIG. 1 shows the worm drive according to the invention

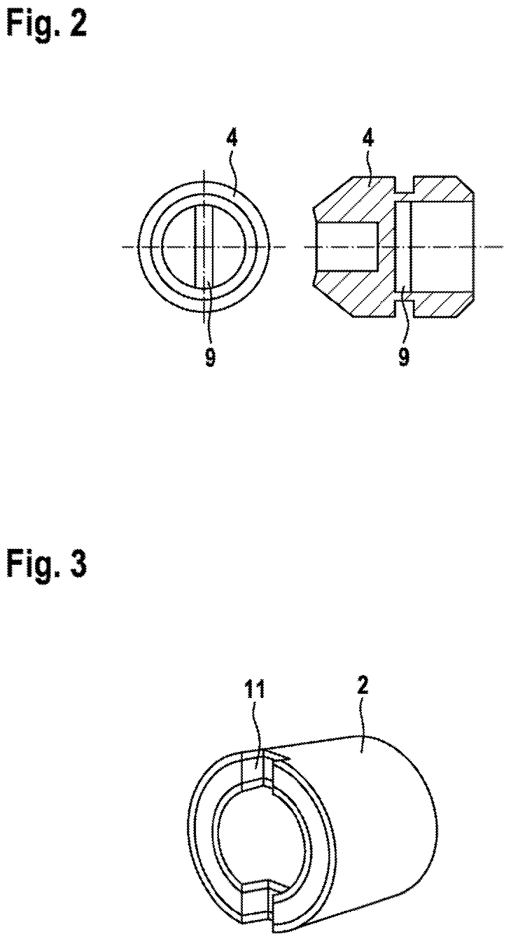

FIG. 2 shows the hub of the coupling

FIG. 3 shows the elastic spring bush

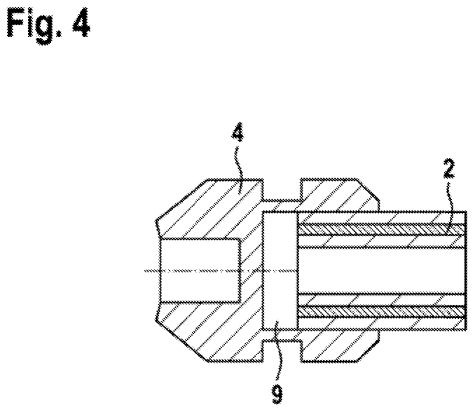

FIG. 4 shows the assembled coupling with the hub and the spring bush

FIG. 1 shows the worm drive according to the invention. An electric motor 8 drives a worm 1. The worm 1 is in engagement with the worm gear 3. The drive shaft 5 of the electric motor 8 is connected to the worm 1 via a coupling, wherein the coupling comprises a hub 4 and an elastic spring bush 2. In this case, the hub 4 is pressed onto the drive shaft 5. The elastic spring bush 2 is pressed onto the worm 1. The hub 4 has an opening, into which the elastic spring bush 2 is pressed.

One side of the worm is then supported by the fixed bearing 6 on the drive shaft 5 of the electric motor 8. The other side of the worm is supported by the oval floating bearing 10. FIG. 1 shows the oval floating bearing 10 again in another, enlarged view. The oval shape allows vertical movements of the worm 1 for backlash compensation, while preventing lateral drifting of the worm 1.

For the preloading of the worm 1 onto the worm gear 3, the center distance a is reduced by a preloading dimension x during assembly.

FIG. 2 shows the hub 4 as an isolated component. On one side, the hub 4 has a bore, by means of which the hub 4 is pressed onto the drive shaft 5. On the other side, the hub 4 has a larger bore, into which the elastic spring bush 2 can be pressed. A key 9 can be arranged in this bore and is preferably formed integrally with the hub from a sintered material. The elastic spring bush 2 can then engage in this key 9 via a slot in order to obtain an additional means of ensuring the transmission of torque.

On the outer circumference of the hub 4, a recess is provided, which serves as an assembly aid, in that an assembly tool can engage there.

FIG. 3 illustrates the elastic spring bush 2 as an isolated component. In this case, a rubber-elastic material is arranged between an outer and an inner ring.

This is preferably produced by extrusion or vulcanization in the rings, resulting in a firm connection between the rubber-elastic material and the two rings. The spring bush 2 can thus damp axial and radial forces, transmit the torque and provide spring loading for the worm.

A slot 11 can be provided on the spring bush 2 and it engages in a key 9 in the hub 4. There is play between the key and the slot. The slot of the inner ring rests against the key only in the case of a corresponding overload. In this way, reliable torque transmission can be ensured.

FIG. 4 illustrates the complete coupling consisting of the hub 4 and the elastic spring bush 2. The elastic spring bush 2 is pressed into the hub 4. In the process, it engages via a slot in the key 9 of the hub 4.

1. A worm drive for a power-assisted steering system of a motor vehicle, comprising:
a worm gear;
a worm configured to mesh with the worm gear;
an electric motor configured to drive the worm;
a coupling; and
a floating bearing,
wherein one side of the worm is connected by the coupling to the electric motor and the other side of the worm is supported in the floating bearing,
wherein the coupling comprises a hub and an elastic spring bush,
wherein the floating bearing is configured to be oval-shaped so as to allow vertical movements of the worm, and
wherein the worm is preloaded onto the worm gear by the coupling.

2. The worm drive as claimed in claim 1, further comprising a fixed bearing configured to support the worm on the drive shaft of the electric motor.

3. The worm drive as claimed in claim 1, wherein:
the hub is pressed onto the drive shaft of the electric motor, and
the worm is pressed into the elastic spring bush.

4. The worm drive as claimed in claim 1, wherein:
the hub has an integrated key,
the elastic spring bush defines a slot, and
the elastic spring bush engages the hub via mating of the slot with the integrated key.

5. The worm drive as claimed in claim 1, wherein:
the elastic spring bush comprises an outer ring and an inner ring, and
the elastic spring bush further comprises a rubber-elastic material is arranged between the outer ring and the inner ring.

6. The worm drive as claimed in claim 1, wherein:
the floating bearing includes an outer ring and an inner ring, and
the floating bearing further includes a rubber-elastic material arranged between the outer ring and the inner ring.
